(19) United States
(12) Patent Application Publication
(10) Pub. No.: US 2023/0399236 A1
(43) Pub. Date: Dec. 14, 2023

(54) TITANIUM DIOXIDE NANOMATERIALS AND METHOD OF MAKING THE SAME

(71) Applicants: Qatar Foundation for Education, Science and Community Development, Doha (QA); Ministry of Municipality and Environment, Doha (QA); Qatar University, Doha (QA)

(72) Inventors: Siham Yousuf Al-Qaradawi, Doha (QA); Yahia Hussein Ahmad, Doha (QA); Mohammed Saif Al-Kuwari, Doha (QA)

(21) Appl. No.: 18/204,607

(22) Filed: Jun. 1, 2023

Related U.S. Application Data
(60) Provisional application No. 63/366,163, filed on Jun. 10, 2022.

(51) Int. Cl. C01G 23/047

(52) U.S. Cl. CPC C01G 23/047

(57) ABSTRACT

Titanium dioxide nanomaterial and a method of making the same are provided. The method includes adding titanium precursor in the aqueous solution; adding citric acid to the aqueous solution; heating the aqueous solution until formation of a gel; carbonizing the gel at a first temperature; and calcining the carbonized gel at a second temperature.

### CROSS-REFERENCE TO RELATED APPLICATION

The present application claims priority to U.S. Provisional Patent Application 63/366,163 having a filing date of Jun. 10, 2022, the entirety of which is incorporated herein by reference.

### BACKGROUND

TiO₂ and TiO₂-based nanomaterials are regarded as one of the most important categories of materials in the last decades owing to their use in a wide range of applications, such as paints, coatings, plastics, fibers, ceramics, catalysts, cosmetics, and energy materials. Different methods have been devoted to the preparation of TiO₂ and doped TiO₂, such as reverse-micelle, microemulsion, chemical precipitation, electrochemical, vapor deposition, oxidation, sol-gel, and hydro/solvothermal synthesis. Despite the diversity in the preparation methods, a number of shortcomings are encountered, such as unsuitability for scalable production, harsh reaction conditions, high cost, utilization of sophisticated instrumentation, use of organic solvents, and manipulation of unstable precursors, such as titanium alkoxides and dihydroxy bis(ammonium lactato)titanium (IV).

The global market of titanium dioxide was estimated to be more than 6.2 million ton in 2020 with an expected annual growth rate of 6% from 2021-2026. The fastest growth rate in the worldwide market is observed in Asia-Pacific, especially in India, China, the Philippines, Vietnam, and Indonesia.

### SUMMARY

According to one non-limiting aspect of the present disclosure, an example embodiment of a method of making titanium dioxide nanomaterial is provided. In one embodiment, the method includes adding a titanium precursor in an aqueous solution; adding a citric acid to the aqueous solution; heating the aqueous solution until the formation of a gel; carbonizing the gel at a first temperature; and calcining the carbonized gel at a second temperature.

Additional features and advantages are described herein and will be apparent from the following Detailed Description and the figures.

### BRIEF DESCRIPTION OF THE FIGURES

Features and advantages of the present disclosure, including a titanium dioxide nanomaterial and method of making the same, described herein may be better understood by reference to the accompanying drawings in which:

FIG. 1: TEM images of (a) TiO₂, (b) Mo—TiO₂, (c) V—TiO₂, and (d) W—TiO₂ according to an embodiment of the present disclosure.

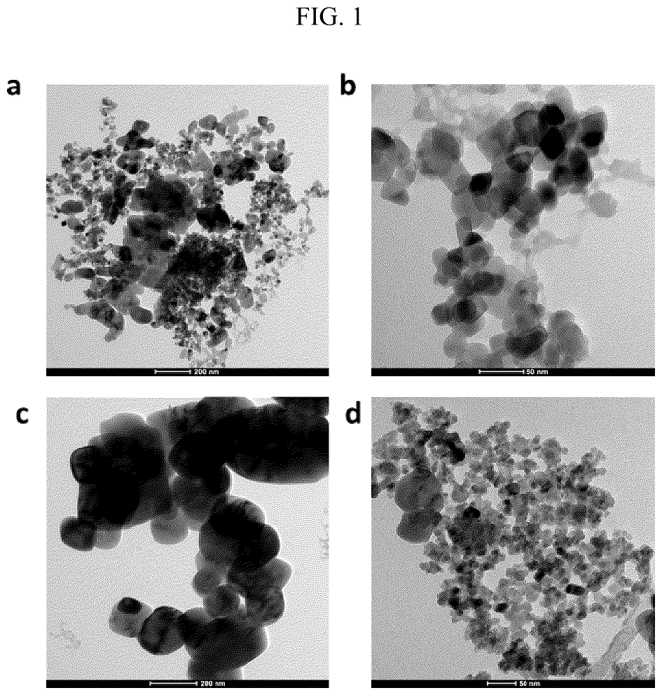

FIG. 2 illustrates PXRD spectra of TiO₂-based samples according to an embodiment of the present disclosure.

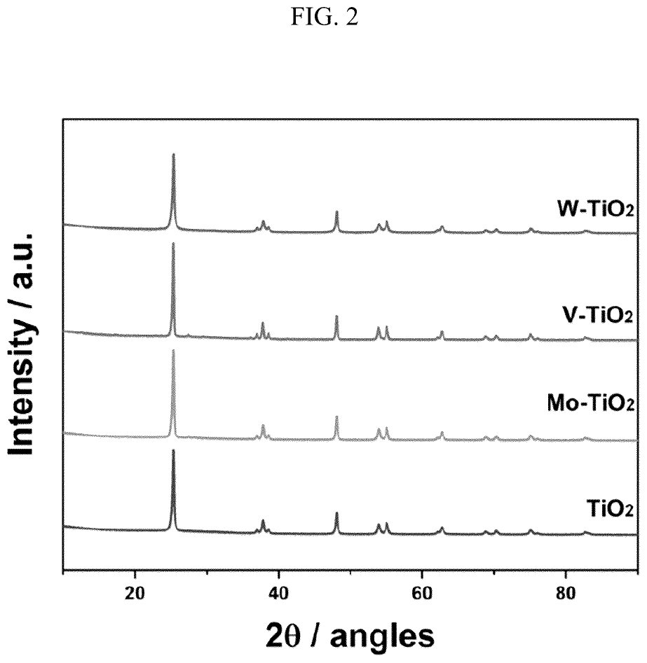

FIG. 3 illustrates Raman spectra of synthesized samples according to an embodiment of the present disclosure.

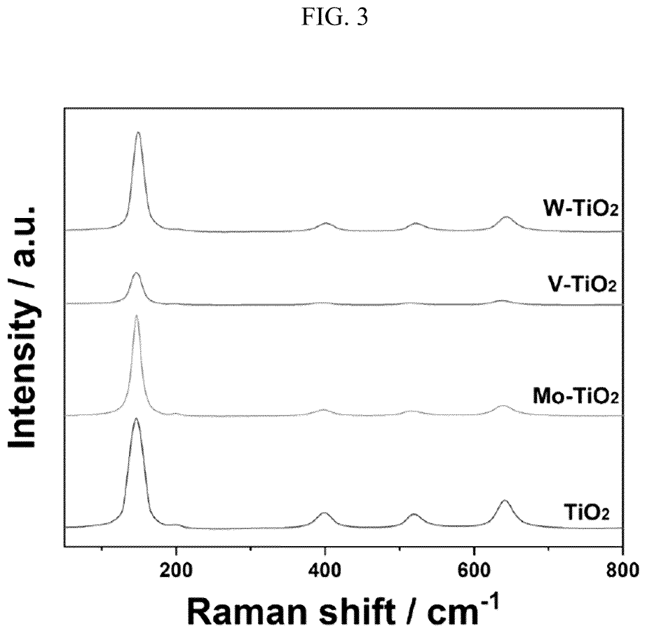

FIGS. 4(a)-(d) illustrate N₂-physisorption isotherms of TiO₂-based samples according to an embodiment of the present disclosure.

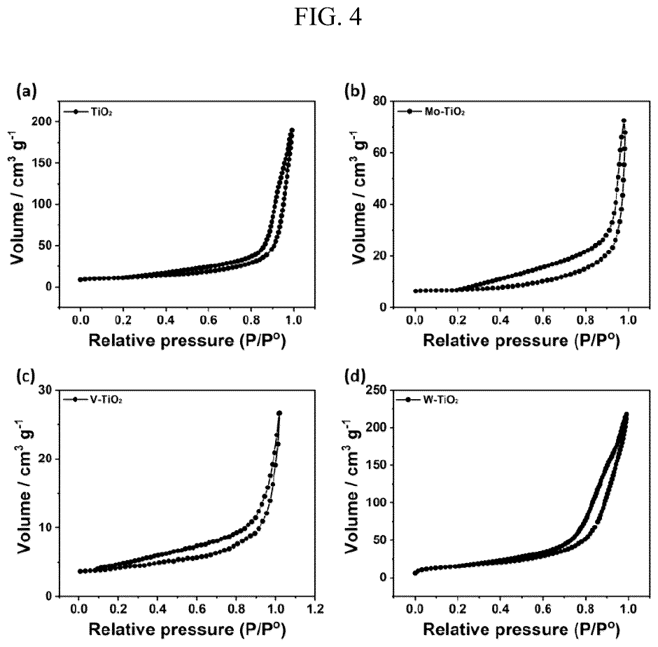

FIGS. 5(a)-(d) illustrate the ζ-potential of TiO₂-based samples as a function of the pH according to an embodiment of the present disclosure.

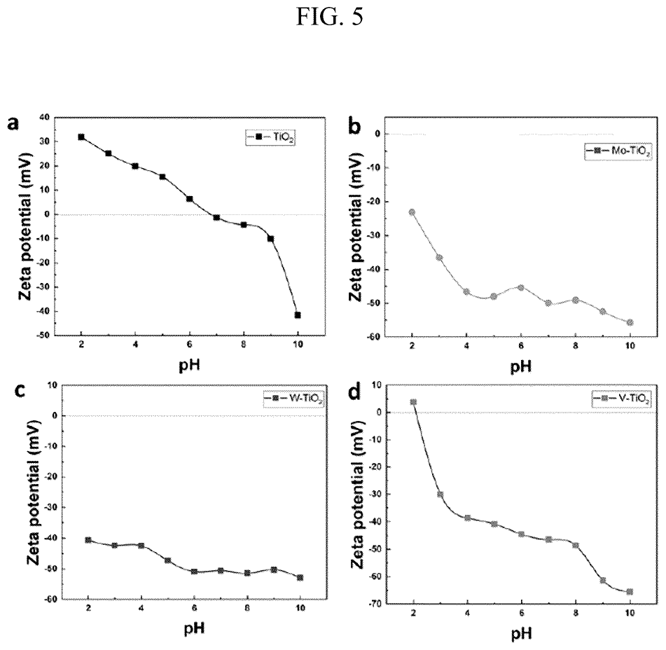

The reader will appreciate the foregoing details, as well as others, upon considering the following detailed description of certain non-limiting embodiments of the present disclosure.

### DETAILED DESCRIPTION

The present disclosure is generally related to a titanium dioxide nanomaterial and the method of making the same.

TiO₂ and metal-doped TiO₂ nanomaterials have triggered increased research interest over the last decades owing to their outstanding physicochemical properties which permit their use in a wide range of applications, such as paints, cosmetics, electrochemical electrodes, gas sensors, solar energy materials, gas sensors, construction materials, supercapacitors, photocatalysis, catalyst supports, and other suitable applications. Different approaches are devoted to the synthesis of un-doped and metal doped-TiO₂, where these approaches are mainly categorized into two main procedures, namely, physical and chemical methods. For example, chemical methods are recognized with composition uniformity, simplicity, and better control of the size and morphology of the nanoparticles. However, such chemical methods encountered shortcomings, such as high temperature and high-pressure requirements, long operation periods, unsuitability of large-scale production, non-homogeneity, use of organic solvents, and limited doping levels.

In the present disclosure, a procedure for the synthesis of un-doped and metal-doped TiO₂ nanoparticles is provided according to an embodiment. The present procedure is amenable to circumvent most of these drawbacks and can be employed, for example, to prepare substantial amounts of a highly-crystalline mesoporous TiO₂ and doped TiO₂ at relatively low temperatures and low input energy, high homogeneity, using a wide variety of dopants, and its application in aqueous medium without the need for any organic solvents. Another valuable advantage of this procedure is that it is not restricted to the synthesis of un-doped and doped TiO₂ only, and thus, it can be used for the synthesis of similar structures for metal oxides that have salts with limited stability in aqueous solutions, such as Sn, Nb, and Zr oxides.

According to an embodiment of the present disclosure, there is provided a synthesis method for crystalline mesoporous metal doped-TiO₂ nanoparticles. The crystalline mesoporous metal doped-TiO₂ nanoparticles can be achieved via a process in an aqueous solution without the need for organic solvents or sophisticated equipment. For example, doped TiO₂ was synthesized by a sol-gel-like approach using ammonium hexafluorotitanate (AHFT) as titanium precursor in an aqueous solution containing citric acid with the addition of the corresponding ammonium salt of the dopant precursor in each case.

As a non-limiting example, 3.84 grams (20 mmol) of citric acid were added to a beaker containing 100 mL of deionized water. Afterward, the solution was heated and stirred until complete dissolution. Then, the corresponding amounts of AHFT and the metal precursor were added under continuous stirring until complete dissolution of the added solids. The pH of the solution was adjusted using a few drops of ammonia solution and the structure modifier is added. Heating was continuous until the evaporation of most solvent and the formation of a gel. The gel was carbonized in air at 250° C. for 4 h and then calcined in air at 600° C. for 4 h at a ramping rate of 5° C. min⁻¹.

According to an embodiment of the present disclosure, a synthesis method for a TiO₂-based nanomaterial is provided. In this synthesis method, no organic solvent is used, and only water is used as a solvent. In addition, citric acid is used as a chelating agent, which enhances the stability of a wide range of metal ions, such as molybdenum, vanadium, tungsten, and the like, thus preventing metal precipitation. The method depends on the complexing of titanium and the metal ion dopant with citric acid to make citrate complexes, which are connected together via extensive hydrogen bonding to form a gel-like polymerized structure. After that, the polymerized interconnected citrate complex is combusted during the heat treatment to form the metal-doped TiO₂ nanoparticle. In this approach, several complications arise from using the organic solvent; the long operation time, water content, and complicated steps are not available. In addition, the combustion of interconnected citrate complexes of titanium and the dopant ions affirms concurrent events, which lead to the formation of homogeneous doped TiO₂ structures rather than heterostructures. In most cases, the formation of these heterostructures cannot be identified by X-ray diffraction (XRD) owing to the high dispersion and small size of the dopant oxide; however, this can be detected by the Raman spectrum, which implies the presence of dopant oxide particles outside the lattice of TiO₂.

In the present disclosure, the synthesis methods as described herein are characterized by several merits such as simplicity, feasibility for large-scale production, absence of organic solvents, and applicability for preparation of a wide range of metals doped-TiO₂ nanoparticles. The synthesis methods are viable to prepare different TiO₂-based nanomaterials, such as TiO₂ and a metal doped-TiO₂. For example, this can be achieved via a simple process in an aqueous solution without the need for organic solvents or sophisticated equipment. The synthesis methods are valid for scalable production in contrast to other processes, such as vapor deposition and solvothermal approaches. The synthesis methods are also a rapid process compared to traditional sol-gel and solvothermal technology.

The synthesis methods as described herein can be further modified in the experimental conditions, such as, the pH and use of other additives that can influence the morphology of the final product according to an embodiment. In addition, the synthesis methods can be applied to other metals, such as, niobium, tin, and zirconium, whose salts suffer from limited stability in aqueous solutions especially at neutral and near-neutral pH values.

In the present disclosure, the synthesis methods as described herein have high feasibility of scalable production. For example, synthesis is implemented in an aqueous solution without the need for organic solvents. Synthesis is executed at ordinary conditions and no harsh reaction conditions are required in terms of reaction time, temperature, and pressure. Some advantages of the synthesis methods are, but not limited to, simplicity, reasonable cost, no need for sophisticated instrumentation, and easy control of the composition and doping ratio of embedded metals. Moreover, the synthesis methods can be applied for application on a metal-doped TiO₂, an undoped, a single metal-doped, a co-doped, and multi-doped TiO₂ nanoparticles. For example, the synthesis methods can be applied to prepare TiO₂ nanoparticles doped with a transition metal, a rare earth metal, other metals and nonmetals, and combinations thereof.

According to an embodiment, the method is applied for the synthesis of three different metal-doped TiO₂ nanoparticles (i.e., Mo-doped, TiO₂, V-doped TiO₂, and W-doped TiO₂), in addition to undoped TiO₂. For example, in the case of V-doped sample, large particles were formed which may reach 200 or more nanometers. However, this can be resolved by tuning the reaction conditions such as the pH, ionic strength, and addition of structure modifiers such as surfactants.

In the present disclosure, the synthesis methods as described herein also have high feasibility for application for the synthesis of other metal oxides that have metal precursors with limited stability in aqueous solutions such as tin oxide, niobium oxide, zirconium oxide and metal-doped derivatives thereof.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method of making a titanium dioxide nanomaterial, comprising:
adding a titanium precursor in an aqueous solution;
adding a citric acid to the aqueous solution;
heating the aqueous solution until the formation of a gel;
carbonizing the gel at the first temperature; and
calcining the carbonized gel at a second temperature.

2. The method of claim 1, further comprises adding a metal dopant precursor to the aqueous solution.

3. The method of claim 1, wherein the first temperature is lower than the second temperature.

4. The method of claim 1, wherein the titanium precursor is an ammonium hexafluorotitanate.

5. The method of claim 2, wherein the TiO₂ is one of a single metal-doped, a co-doped, and a multi-doped TiO₂ nanoparticle.

6. The method of claim 2, wherein the metal dopant precursor includes a transition metal, a rare earth metal, or combinations thereof.

7. A method of making a nanomaterial, comprising:
adding a metal precursor in an aqueous solution;
adding a citric acid to the aqueous solution;
heating the aqueous solution until the formation of a gel;
carbonizing the gel at the first temperature; and
calcining the carbonized gel at a second temperature.

8. The method of claim 7, wherein the metal precursor is one of Sn, Nb, and Zr.

9. The method of claim 7, further comprises adding a metal dopant precursor to the aqueous solution.

10. The method of claim 7, wherein the first temperature is lower than the second temperature.

11. The method of claim 9, wherein the metal dopant includes a transition-metal ion, a rare earth metal ion, or combinations thereof.

12. The method of claim 9, wherein the metal dioxide nanomaterial includes one or more of a Mo-doped TiO₂ (molybdenum), a V-doped TiO₂ (vanadium), and a W-doped TiO₂ (tungsten).
